(19) United States
(12) Patent Application Publication
(10) Pub. No.: US 2004/0225528 A1
(43) Pub. Date: Nov. 11, 2004

(54) Interactive method and system for creating, validating, verifying and dispensing prescriptions

(76) Inventor: Charles W. Brock, Tampa, FL (US)

Correspondence Address: Arthur W. Fisher, III, Suite 316, 5553 West Waters Avenue, Tampa, FL, 33634, US

(21) Appl. No.: 10/191,370

(22) Filed: Jul. 3, 2002

(51) Int. Cl. G06F 17/60

(52) U.S. Cl. 705/2

(57) ABSTRACT

An interactive method and system for creating, validating, verifying and dispensing or filling patient prescriptions through a network of member health care providers, a central web site and member pharmacies operatively coupled by a data communication link capable of transferring data and information therebetween wherein each member health care provider has a computer including information processing and storage capabilities to create and validate individual patient prescriptions to be provided to any member pharmacy, the central web site has a computer including information processing and data storage capabilities for processing and storing individual patient prescription data communicated thereto by member health care providers and member pharmacies and to verify the authenticity of individual patient prescriptions upon receipt of a request from any member pharmacy and each member pharmacy has a computer including information processing and storage capabilities to generate a request to verify the authenticity of individual patient prescriptions from the central web site created by any member health care provider and to receive verification from the central web site of the authenticity of individual patient prescriptions prior to dispensing the individual patient prescriptions.

### BACKGROUND OF THE INVENTION

1. Field of the Invention

A method and system for creating, validating, verifying and dispensing, or filling patient prescriptions.

2. Description of Prior Art

In the practice of medicine, certain medications are available to patients only by prescription prepared by a medical professional. Generally, the prescribing professional issues a written prescription to authorize dispensing of the prescribed medication at a point of supply such as a retail pharmacy.

Often, the prescriptions and indications are abbreviated and difficult to decipher do to illegible handwriting rendering it difficult for a pharmacist to determine the proper medicine to dispense. In some cases, the pharmacist may even dispense the wrong medicine or indicate the incorrect regimen.

Furthermore, there is an enormous problem in the United States with the abuse of pharmaceutical agents. It is estimated that the illicit business of selling pharmaceuticals for abuse amounts to an annual $30 billion industry. By some reports at least 70% of the drug enforcement cases involve pharmaceuticals. Drug Enforcement Administration (DEA) data for the years 1993-1998 shows the top five most commonly diverted abused pharmaceutical drugs are hydrocodone, hydromorphone, oxycodone, benzodiazepines and codeine combinations. Unfortunately, review of national emergency room records reveals there were more overdoses involving benzodiazepines as a group than from marijuana, heroin or cocaine combined. There are estimates that as many as 3000 deaths have occurred through inappropriate or unauthorized use of controlled pharmaceuticals. Accordingly, the DEA and numerous state agencies expend an enormous amount or resources to combat this problem.

The illicit diversion of pharmaceutical drugs may occur through theft by medical and non-medical personnel but primarily occurs through various schemes and fraudulent prescriptions. These schemes include patients altering the dosage or quantity of medication noted on prescription; prescription pads are stolen from the physician office and prescriptions are written for fictitious patients; drug abusers call in their own prescriptions and give their own number for call back confirmation; and fraudulent prescriptions are created by computers for nonexistent doctors or from copied legitimate prescriptions.

As previously noted, the number of fatalities and injuries that result from the wrong medication or dosage being issued by a pharmacy. It is estimated that 7000 people die each year from taking incorrect medicine or dosage.

Numerous efforts have been undertaken to protect and safeguard the proper distribution and dispensing of prescription medicines. Several such methods or systems are disclosed and described in the patents below.

U.S. Pat. No. 5,883,370 shows an automated prescription filling system to generate a bar coded prescription. The prescription print out includes the bar code and the pertinent information including drug specification, dose strength, taking instructions, physician identification in human readable form. The patient takes the prescription into the pharmacy and the pharmacist fills the prescription either in the conventional fashion since the prescription contains all the necessary information in typed form, or the pharmacist scans the bar code(s) and the prescription is automatically entered into pharmacy computer. The pharmacist then selects the matching drug from the shelf container and scans the NDC (National Drug Code) bar code on the container. The system confirms a match between the NDC and the prescription and then permits issue of the prescription, printing out a vial label.

U.S. Pat. No. 6,055,507 shows a method for dispensing, tracking and managing pharmaceutical products linking prescribers and pharmacies to a central computing station. The media is encoded with information that identifies a particular pharmaceutical trial product, such as by magnetic encoding similar to that used with credit cards. The media is distributed to participating medical doctors or prescribers who then activate the media via the central computing station. The prescriber then transfers the activated media to patients who then present the media to participating pharmacies. Before filling the pharmaceutical trial product identified by the media, the pharmacy validates the media via a link with the central computing station. Then, the pharmacy dispenses the prescribed pharmaceutical trial product. The central computing station also includes a database that records data related to the use of the media so that all pharmaceutical trial products can be accounted for.

U.S. Pat. No. 6,098,892 teaches a device and method for converting product-specific identification numbers associated with bar code indicia on pharmaceutical products to an industry standard identification number. The process involves reading a bar code indicia, converting the indicia into an input string and standardizing the input string by means of adding or subtracting characters in accordance with rules based on the bar code type and length of the input string. By means of the invention pharmaceutical products of two different sources may be compared to determine if they contain the same drug as determined by the standard identification number.

U.S. Pat. No. 6,152,364 relates to a global pharmacy system for prescribing and delivering medicaments to a patient. The system includes at least one input unit with which a doctor is capable of entering, inter alia, a prescription of a medicament for a patient together with the patient's identity into the system. The input unit then generates a prescription signal corresponding to the prescription entered. A pharmacy computer coupled to the input unit further processes the prescription signal received from the input unit and generates a control signal corresponding to the prescription. Under the supply of the control signal generated by the pharmacy computer, an automatic dispenser dispenses the described medicament to the patient. The system incorporates a patient history feature and a medical intervention capability.

Additional examples of the prior art are found in U.S. Pat. No. 3,848,112; U.S. Pat. No. 4,476,381; U.S. Pat. No. 4,835,372; U.S. Pat. No. 4,857,716; U.S. Pat. No. 5,684,288 and U.S. Pat. No. 5,992,890.

### SUMMARY OF THE INVENTION

The present invention relates to an interactive method and system for creating, authenticating, verifying and dispensing or filling patient prescriptions through a network comprising a central web site, a plurality of member health care providers and a plurality of member pharmacies operatively coupled by a data communication link capable of transferring data and information therebetween to create secure individual patient prescriptions to request and verify the authenticity of such individual patient prescriptions prior to filling the individual patient prescriptions.

The present invention is implemented through the use of an input device such as a terminal, handheld computer or personal data assistant (PDA) that enables a physician or other authorized person of a member health care provider to create encoded/encrypted prescription information in bar code form that appears on a corresponding printed prescription.

Each individual prescription generating program is serialized and issued to an individual authorized health care provider and corresponding terminal or PDA identified by a distinct serial number. Thus, if a program is stolen or improperly transferred or downloaded, the program as well as patient prescriptions created by the terminal or input device are flagged and voided throughout the system.

The encoded bar code information can include such data as patient name, birthday, patient social security number or other identifying designation or number, physician registry number, medication name, dosage, dispensing number and date of prescription. Appropriate information is added to the script and printed for signature by the practitioner and provided to the patient.

The DEA number may be provided only through the encoded bar code to reduce the potential for illicit use.

The patient presents the patient prescription to a member pharmacy to dispense the medicine. A pharmacist at the member pharmacy requests authentication of the individual patient prescription by transmitting a prescription authorization request including the bar code information and other relevant information to the central web site.

After entering the central web site, the pharmacist enters the patient name, the medication name followed by the bar code information with bar code reader or directly inputting the information. This information is uploaded to the website and de-encrypted.

If the individual patient prescription is valid, the pharmacist will receive verification that the individual prescription is authentic. This is accomplished by downloading the specific information regarding the individual patient, medication, dosage, dispense number and physician back to the pharmacy user.

The central web site will have secure server line (SSL) protection similar to the technology used to protect credit card transactions.

The central web site stores all validated prescription information for comparison to new patient prescriptions for the same patient to prevent duplicate prescriptions. In addition, the medications can be compared to prevent medication interaction and/or ensure formulary compliance. Controlled medications will also be flagged if registry notes filling of same or similar medication in the last 30 days. The pharmacist will then be able to discern if such medication filling is warranted. Reasons for warranting such filling would include legitimate use of all previous prescribed medication; change of controlled medication by physician; or increase or change in patient's medical condition. Pharmacy would then be queried in regard to medication being filled or not. If filled, then this medication would be added to the patient's list with all relevant information for future comparison. The patient specific medication database containing all medications filled through the authentication process can be created during the verifying/authorizing process.

If a patient had a medication filled at a pharmacy not using such measure, then the medication would not appear. The pharmacy or physician would have the option to enter all the known medications for the patient through a secured entry site. Due to privacy issues, there will be no method for the pharmacy or physician to download a list of the patient's medications. Security and privacy of all patient health information is of utmost importance. All necessary means will be taken to ensure the integrity of this system.

Upon verification from the central web site, the member pharmacy will determine if the information received from the central web site matches the prescription as written as the final authentication. This medication will also be compared to a databank list compiled for the patient. Potential medication interactions will be identified and flagged for pharmacist.

The invention accordingly comprises the features of construction, combination of elements, and arrangement of parts that will be exemplified in the construction hereinafter set forth, and the scope of the invention will be indicated in the claims.

### BRIEF DESCRIPTION OF THE DRAWINGS

For a fuller understanding of the nature and object of the invention, reference should be had to the following detailed description taken in connection with the accompanying drawings in which:

FIG. 1 is a schematic of the method and system of the present invention in a network environment.

FIG. 2 depicts a computer used to implement the method and system of the present invention in the network environment.

FIG. 3 depicts a printed patient prescription generated by the method and system of the present invention.

FIG. 4 depicts a second printed patient prescription by the method and system of the present invention.

FIGS. 5 through 8 sequentially show various screen displays of the method and system of the present invention.

FIG. 9 is a flow chart of some of the sequential functions associated with the method and system of the present invention.

Similar reference characters refer to similar parts throughout the several views of the drawings.

### DETAILED DESCRIPTION OF THE PREFERRED EMBODIMENT

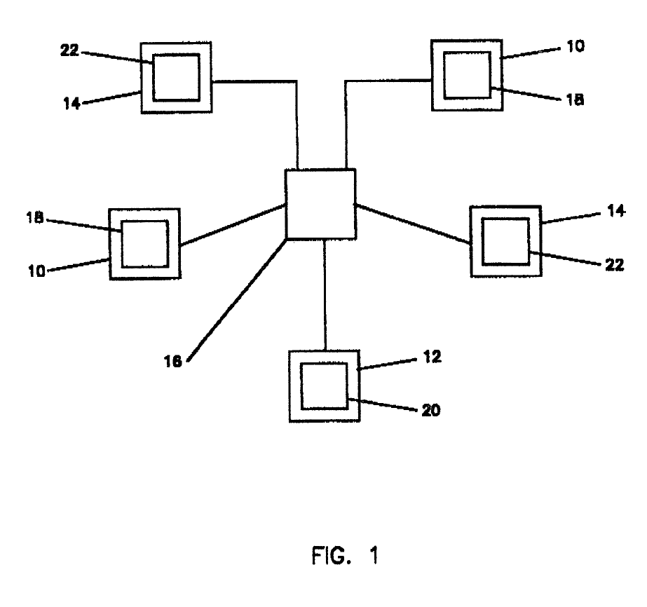

As shown in FIG. 1, the present invention relates to an interactive method and system for creating, validating, verifying and dispensing or filling patient prescriptions through a network of member health care providers each indicated as 10, a central web site 12 and member pharmacies each indicated as 14 operatively coupled by a data communication link 16 capable of transferring data and information therebetween. Each member health care provider 10 has a health care provider computer 18 including information processing and storage capabilities to create and validate individual patient prescriptions to be provided to any member pharmacy 14, the central web site 12 has a web site computer 20 including information processing and data storage capabilities for processing and storing individual patient prescription data communicated thereto by member health care providers 10 and member pharmacies 14 and for verifying the authenticity of individual patient prescriptions upon receipt of a request from any member pharmacy 14 and each member pharmacy 14 has a pharmacy computer 22 including information processing and storage capabilities to generate a request to verify the authenticity of individual patient prescriptions from the central web site 12 created by any member health care provider 10 and to receive verification from the central web site 12 of the authenticity of individual patient prescriptions prior to dispensing the individual patient prescriptions as described more fully hereinafter.

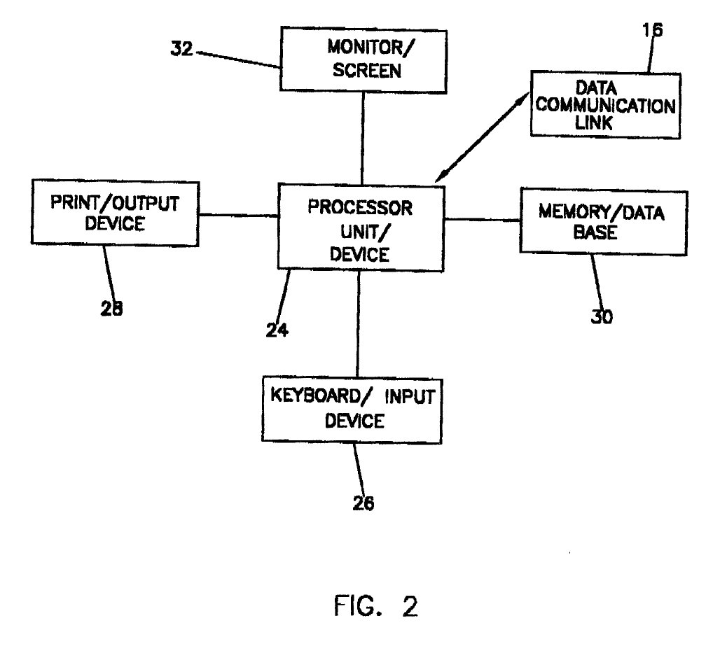

As shown in FIG. 2, each computer 18, 20 and 22 comprises a processor unit or device 24 operatively coupled to a keyboard or input device 26, a printer or output device 28, a memory or database 30 and a monitor or screen 32. As previously described, the computers 18, 20 and 22 are operatively coupled through the data communication link 16. The data communication link 16 may comprise any suitable state or the art transmitting/receiving system or means. The keyboard or input device 26 may be terminal connected or wired to the processor unit or device 24 or may be wireless terminal such as a personal digital assistant (PDA) as described hereinafter.

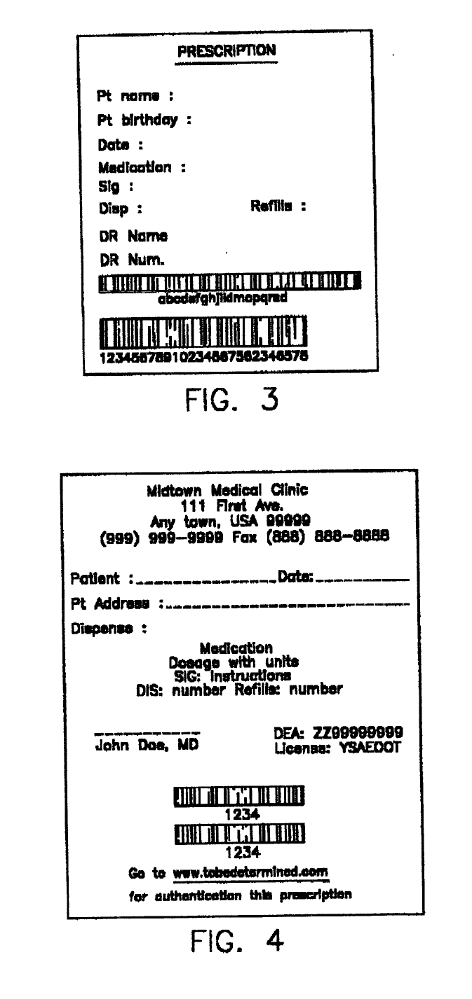

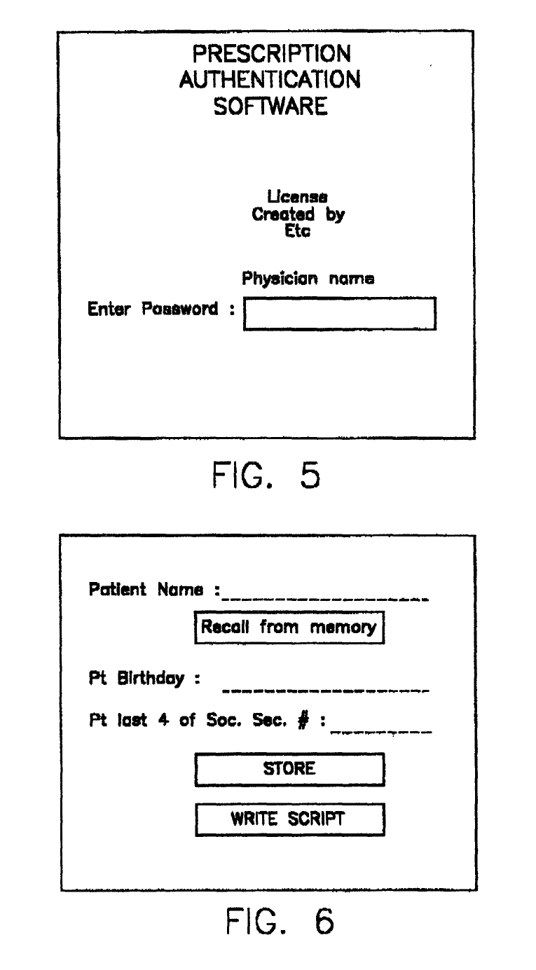

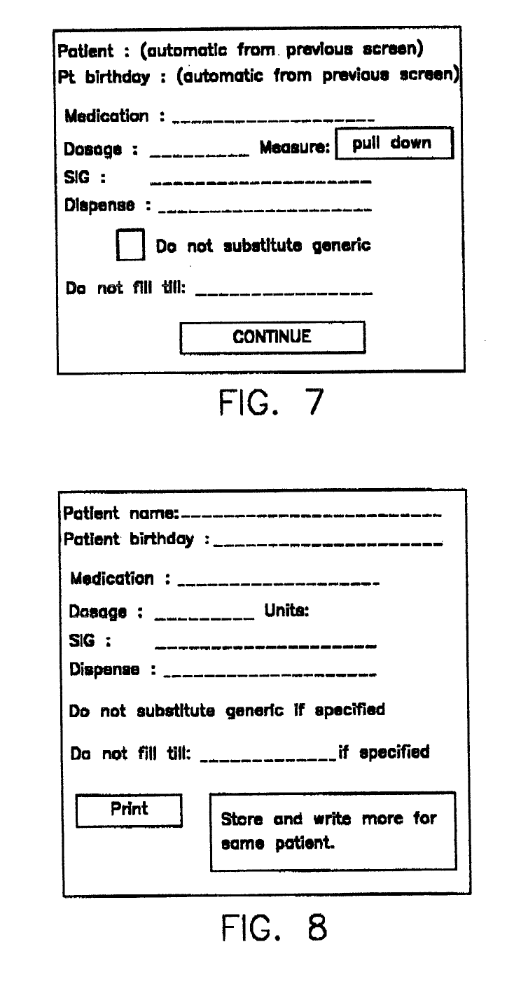

The program allows the authorized health care provider to interface through the keyboard or input device 26 to input all necessary information shown in FIG. 3 or 4 to create an individual printed patient prescription as shown below. Respective member health care providers 10 can maintain individual patient prescription histories in the memory or database 30. FIGS. 5 through 8 depict various help screens available to individual authorized personnel inputting information into the respective member health care provider computer.

Recurring individual patient information including name, address, phone number, fax number, other identifying information such as social security number are entered into the respective member health care provider memory or database 30 for repeated use.

The following is entered for each individual patient prescription or recalled from memory 30: patient name, patient birthday, current date, do not dispense until X date as applicable, medication name (present with checkbox to mark if no generic substitution), SIG (these are the instructions for how to take medication), dispense (quantity) and refills (number of times prescription can be refilled).

Following this information appears physician name, physician license number, physician DEA number and line for authorized signature.

This information can be programmed for repeated use on all prescriptions. The DEA number can be left off the printed prescription and only encoded via bar code. In this way, the member pharmacy 14 could obtain the DEA number for filling purposes, but abusers would not have access to these numbers for illicit use.

At the bottom of the prescription appears the encrypted bar codes or other machine readable encrypted code containing the necessary encoded elements.

The encoded information includes patient name, birthday, last four patient social security number or other personal identifying number, physician registry number, medication name, dosage, dispense number, refills number and date of prescription. Each health care person authorized to write prescriptions under the system has a unique identifier and unique bar code that is changed periodically to reduce the likelihood of a breach of security. The central web site 12 has each unique identifier and corresponding unique bar code, as updated, to compare against requests from member pharmacies 14 to generate the verification and authentication message.

Below is a representation of such a script with noted elements.

Prescription

| | |
|---|---|
| Patient Name: | John Brown |
| Patient Birthday: | Dec. 05, 1955 |
| Date: | May 05, 2002 |
| Medication: | Amoxicilin |
| | Sig: 500 mgs PO q 8 hrs for 7 days |
| Disp: | 28 |
| Dr. Name: | C Brock |
| Dr. Number: | VE1234567 |

|||||||||||||||||||||||||||||||||||||||||||||||||||||||||||||||||||||||||||||||||||||||||||||||||||||||||||||||
abcdefghijklmnopqrst
|||||||||||||||||||||||||||||||||||||||||||||||||||||||||||||||||||||||||||||||||||
12345678901234567890123450

The necessary information is entered, the prescription is printed on a portable printer or desktop printer or other output device 28 to be taken to a member pharmacy 14. Alternatively, the individual patient prescription can be electronically transferred to a member pharmacy 14 over data communication link 16.

The central web site 12 will have secure server link (SSL) protection. After entering the central web site 12, a member pharmacy 14 enters the patient name and medication name and then enters the bar code information by use of bar code reader or directly entering the number. This information is uploaded to the central web site 12 and de-encrypted. Specific information regarding the patient, medication, dosage, dispense number and physician is then downloaded back to the requesting member pharmacy 14. The member pharmacy 14 verifies that this information matches the prescription as written by comparing the text of the prescription with the text returned from the central web site 12 thus authenticating the prescription. In addition, the central web site 12 can generate and transmit a monitor flag to the requesting member pharmacy 14 if the prescription writer's unique identifier does not match the encrypted bar code for that particular prescription. This medication will also be compared to data bank list compiled for the patient. Potential medication interactions will be identified and flagged for the requesting member pharmacy 14. Controlled mediations are also flagged for the requesting member pharmacy 14 if registry notes filling of same or similar medication with a predetermined period of time such as thirty (30) days. The pharmacist of the member pharmacy 14 will determine if the medication should be filled. Reasons for warranting such filling include legitimate use of all previous prescribed medication, change of controlled medication by physician, or increase or change in patient's medical condition. The member pharmacy 14 is then queried by the central web site 12 to determine if the prescription was filled. If filled, this medication would be added to the patient's list with all relevant information in the memory or database 30 of both the member pharmacy 14 and the central web site 12.

The patient specific medication database 30 should contain all medications filled through the authentication process. If a patient had a medication filled by a pharmacy outside the network, the medication will not, of course, be in database 30 of the central web site 12.

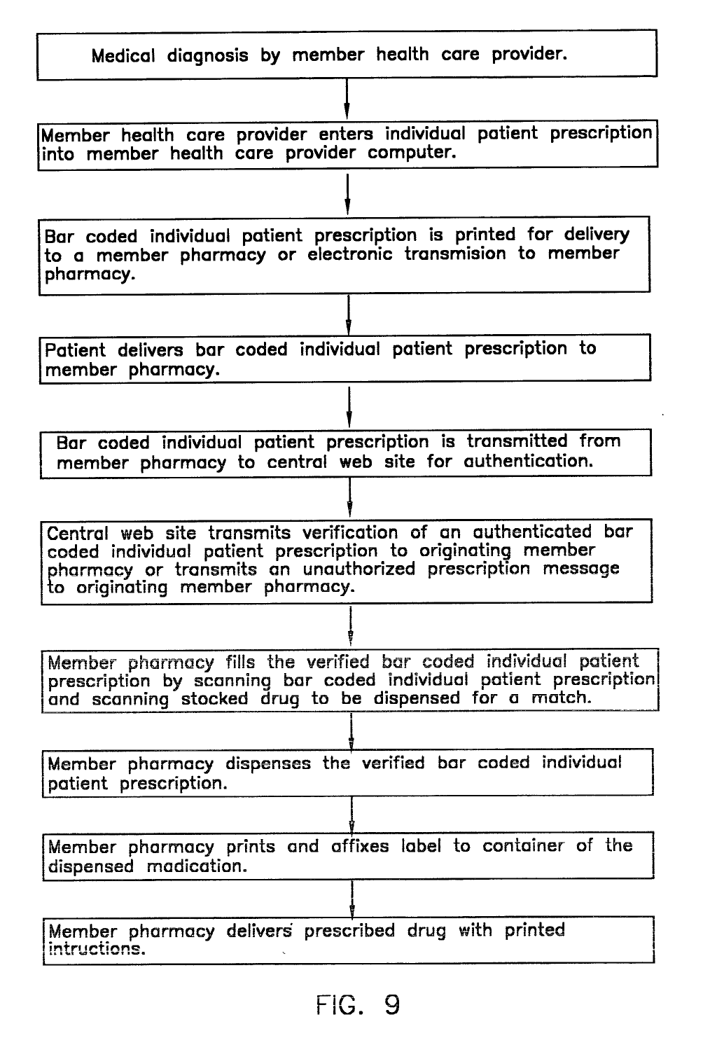

FIG. 9 depicts certain steps for implementing the method and system of the present invention. The method of the present invention comprises the steps of:

authorizing health care provider and pharmacy members to the network

entry of member health care provider information and member pharmacy information into central web site database upon becoming authorizing members of the network

medical diagnosis by member health care provider

member health care provider enters individual patient prescription into member health care provider computer

bar coded individual patient prescription is printed and delivered to a member pharmacy or electronic transmission to member pharmacy

coded individual patient prescription is transmitted from member pharmacy to central web site for authorization and verification

central web site processes verification request

individual patient prescription is compared to a data bank list compiled for the patient

central web site transmits verification of an authenticated bar coded individual patient prescription to originating member pharmacy or transmits an unauthorized prescription message to requesting member pharmacy

information regarding the patient, medication, dosage, dispense number and physician is transmitted to the requesting member pharmacy

potential medication interactions are identified and flagged, controlled medications are also flagged if registry notes filling of same or similar medication within a predetermined period to requesting member pharmacy

member pharmacy verifies that this information matches the prescription as written and authenticated

member pharmacy fills the verified bar coded individual patient prescription by scanning bar coded individual patient prescription and scanning stocked drug to be dispensed for a match

member pharmacy dispenses the verified bar coded individual patient prescription

member pharmacy prints and affixes label to container of the dispensed medication

member pharmacy delivers prescribed drug with printed instructions

member pharmacy is queried by central web site if prescription was filled

if filled, this medication is added to the individual patient's list with all relevant information for future medication

The member health care provider 10 or member pharmacy 14 has an option to enter all the known medications for the patient through a secured entry site. Due to privacy issues, there will be no method for the pharmacy or physician to download a list of the patient's medications. Security and privacy of all patient health information is of utmost importance. All necessary means will be taken to ensure the integrity of the information.

The central web site 12 can also serve as a site for disseminating medical information to subscribers. This may include new research findings, new medication releases, alerts or updates on medications as well as practitioner education forums for CE credits and medical literature reviews.

The present method and system provides several significant benefits to patients, member health care providers 10 and member pharmacies 14. The illicit use of prescription medications t would be reduced. Liability of member health care providers 10 would be reduced where patients misuse or obtain medication fraudulently. Medication errors due to misread prescriber writing would be reduced or eliminated.

Similarly, member pharmacies 14 liability can be reduced for misused medications and misfilled prescriptions.

It will thus be seen that the objects set forth above, among those made apparent from the preceding description are efficiently attained and since certain changes may be made in the above construction without departing from the scope of the invention, it is intended that all matter contained in the above description or shown in the accompanying drawing shall be interpreted as illustrative and not in a limiting sense.

It is also to be understood that the following claims are intended to cover all of the generic and specific features of the invention herein described, and all statements of the scope of the invention that, as a matter of language, might be said to fall therebetween.

Now that the invention has been described,

What is claimed is:

1. An interactive method and system for creating, validating, verifying and dispensing or filling patient prescriptions through a network of member health care providers, a central web site and member pharmacies operatively coupled by a data communication link capable of transferring data and information therebetween wherein each member health care provider has a computer including information processing and storage capabilities to create and validate individual patient prescriptions to be provided to any member pharmacy, the central web site has a computer including information processing and data storage capabilities for processing and storing individual patient prescription data communicated thereto by member health care providers and member pharmacies and to verify the authenticity of individual patient prescriptions upon receipt of a request from any member pharmacy and each member pharmacy has a computer including information processing and storage capabilities to generate a request to verify the authenticity of individual patient prescriptions from the central web site created by any member health care provider and to receive verification from the central web site of the authenticity of individual patient prescriptions prior to dispensing the individual patient prescriptions.

2. The interactive method and system for creating, validating, verifying and dispensing or filling patient prescriptions of claim 1 wherein each health care person authorized to write prescriptions under the system has a unique identifier and unique machine readable code.

3. The interactive method and system for creating, validating, verifying and dispensing or filling patient prescriptions of claim 2 wherein the central web site has each unique identifier and corresponding unique machine readable code to compare against requests from member pharmacies to generate the verification and authentication message.

4. The interactive method and system for creating, validating, verifying and dispensing or filling patient prescriptions of claim 3 wherein said unique machine-readable code is a bar code.

5. The interactive method and system for creating, validating, verifying and dispensing or filling patient prescriptions of claim 2 wherein the unique identifier and unique machine readable code is changed periodically.

6. The interactive method and system for creating, validating, verifying and dispensing or filling patient prescriptions of claim 2 wherein after entering the central web site, a member pharmacy enters the patient name and medication name and then enters the machine readable code information by use of code reader.

7. The interactive method and system for creating, validating, verifying and dispensing or filling patient prescriptions of claim 6 wherein information is uploaded to the central web site and de-encrypted, processed, then specific information regarding the patient, medication, dosage, dispense number and physician is then downloaded back to the requesting member pharmacy.

8. The interactive method and system for creating, validating, verifying and dispensing or filling patient prescriptions of claim 7 wherein the member pharmacy verifies that this information matches the prescription as written by comparing the text of the prescription with the text returned from the central web site to authenticate the prescription.

9. The interactive method and system for creating, validating, verifying and dispensing or filling patient prescriptions of claim 8 the member pharmacy is then queried by the central web site to determine if the prescription was filled and, if filled, the medication is added to the patient's list with all relevant information in the database of both the member pharmacy and the central web site.

10. The interactive method and system for creating, validating, verifying and dispensing or filling patient prescriptions of claim 7 wherein the central web site generates and transmits a monitor flag to the requesting member pharmacy if the prescription writer's unique identifier does not match the encrypted machine readable code for that particular prescription.

11. The interactive method and system for creating, validating, verifying and dispensing or filling patient prescriptions of claim 7 wherein the medication will also be compared to data bank list compiled for the patient and potential medication interactions will be identified and flagged for the requesting member pharmacy.

12. The interactive method and system for creating, validating, verifying and dispensing or filling patient prescriptions of claim 7 wherein controlled mediations are flagged for the requesting member pharmacy if registry notes filling of same or similar medication with a predetermined period of time.

13. The interactive method and system for creating, validating, verifying and dispensing or filling patient prescriptions of claim 7 wherein the central web site generates and transmits a monitor flag to the requesting member pharmacy if the prescription writer's unique identifier does not match the encrypted machine readable code for that particular prescription and wherein the medication will also be compared to data bank list compiled for the patient and potential medication interactions will be identified and flagged for the requesting member pharmacy

14. The interactive method and system for creating, validating, verifying and dispensing or filling patient prescriptions of claim 13 wherein controlled mediations are also flagged for the requesting member pharmacy if registry notes filling of same or similar medication with a predetermined period of time.

15. The interactive method and system for creating, validating, verifying and dispensing or filling patient prescriptions of claim 7 wherein the medication will also be compared to data bank list compiled for the patient and potential medication interactions will be identified and flagged for the requesting member pharmacy and wherein controlled mediations are also flagged for the requesting member pharmacy if registry notes filling of same or similar medication with a predetermined period of time.

16. The interactive method and system for creating, validating, verifying and dispensing or filling patient prescriptions of claim 7 wherein the central web site generates and transmits a monitor flag to the requesting member pharmacy if the prescription writer's unique identifier does not match the encrypted machine readable code for that particular prescription and wherein controlled mediations are also flagged for the requesting member pharmacy if registry notes filling of same or similar medication with a predetermined period of time such as thirty (30) days.

17. The interactive method and system for creating, validating, verifying and dispensing or filling patient prescriptions of claim 1 includes authorizing health care provider and pharmacy members to the network; entry of member health care provider information and member pharmacy information into central web site database upon becoming authorizing members of the network; medical diagnosis by member health care provider; member health care provider enters individual patient prescription into member health care provider computer; machine readable coded individual patient prescription is printed and delivered to a member pharmacy or electronic transmission to member pharmacy; coded individual patient prescription is transmitted from member pharmacy to central web site for authorization and verification; central web site processes verification request; individual patient prescription is compared to a data bank list compiled for the patient; central web site transmits verification of an authenticated machine readable coded individual patient prescription to originating member pharmacy or transmits an unauthorized prescription message to requesting member pharmacy; information regarding the patient, medication, dosage, dispense number and physician is transmitted to the requesting member pharmacy; member pharmacy verifies that this information matches the prescription as written and authenticated; member pharmacy fills the verified machine readable coded individual patient prescription; member pharmacy dispenses the verified machine readable coded individual patient prescription.

18. The interactive method and system for creating, validating, verifying and dispensing or filling patient prescriptions of claim 17 wherein potential medication interactions are identified and flagged.

19. The interactive method and system for creating, validating, verifying and dispensing or filling patient prescriptions of claim 18 wherein controlled medications are flagged if registry notes filling of same or similar medication within a predetermined period to requesting member pharmacy.

20. The interactive method and system for creating, validating, verifying and dispensing or filling patient prescriptions of claim 19 wherein member pharmacy is queried by central web site if prescription was filled and, if filled, medication is added to the individual patient's list with all relevant information for future medication.

21. The interactive method and system for creating, validating, verifying and dispensing or filling patient prescriptions of claim 17 wherein member pharmacy is queried by central web site if prescription was filled and, if filled, medication is added to the individual patient's list with all relevant information for future medication.

22. The interactive method and system for creating, validating, verifying and dispensing or filling patient prescriptions of claim 21 wherein controlled medications are also flagged if registry notes filling of same or similar medication within a predetermined period to requesting member pharmacy.

23. The interactive method and system for creating, validating, verifying and dispensing or filling patient prescriptions of claim 17 wherein controlled medications are flagged if registry notes filling of same or similar medication within a predetermined period to requesting member pharmacy.

24. The interactive method and system for creating, validating, verifying and dispensing or filling patient prescriptions of claim 17 includes authorizing health care provider and pharmacy members to the network; entry of member health care provider information and member pharmacy information into central web site database upon becoming authorizing members of the network; medical diagnosis by member health care provider; member health care provider enters individual patient prescription into member health care provider computer; machine readable coded individual patient prescription is printed and delivered to a member pharmacy or electronic transmission to member pharmacy; coded individual patient prescription is transmitted from member pharmacy to central web site for authorization and verification; central web site processes verification request; individual patient prescription is compared to a data bank list compiled for the patient; central web site transmits verification of an authenticated machine readable coded individual patient prescription to originating member pharmacy or transmits an unauthorized prescription message to requesting member pharmacy; information regarding the patient, medication, dosage, dispense number and physician is transmitted to the requesting member pharmacy; member pharmacy verifies that this information matches the prescription as written and authenticated; member pharmacy fills the verified machine readable coded individual patient prescription; member pharmacy dispenses the verified machine readable coded individual patient prescription.

25. The interactive method of claim 1 wherein said method comprises the steps of authorizing health care provider and pharmacy members to the network; entry of member health care provider information and member pharmacy information into central web site database upon becoming authorizing members of the network; medical diagnosis by member health care provider; member health care provider enters individual patient prescription into member health care provider computer; machine readable coded individual patient prescription is printed and delivered to a member pharmacy or electronic transmission to member pharmacy; coded individual patient prescription is transmitted from member pharmacy to central web site for authorization and verification; central web site processes verification request; individual patient prescription is compared to a data bank list compiled for the patient; central web site transmits verification of an authenticated machine readable coded individual patient prescription to originating member pharmacy or transmits an unauthorized prescription message to requesting member pharmacy; information regarding the patient, medication, dosage, dispense number and physician is transmitted to the requesting member pharmacy; potential medication interactions are identified and flagged, controlled medications are also flagged if registry notes filling of same or similar medication within a predetermined period to requesting member pharmacy; member pharmacy verifies that this information matches the prescription as written and authenticated; member pharmacy fills the verified machine readable coded individual patient prescription; member pharmacy dispenses the verified machine readable coded individual patient prescription; member pharmacy prints and affixes label to container of the dispensed medication; member pharmacy delivers prescribed drug with printed instructions; member pharmacy is queried by central web site if prescription was filled; and if filled, this medication is added to the individual patient's list with all relevant information for future medication.

26. The interactive method and system for creating, validating, verifying and dispensing or filling patient prescriptions of claim 25 wherein said unique machine-readable code is a bar code.
